(19) United States
(12) Patent Application Publication
(10) Pub. No.: US 2002/0193125 A1
(43) Pub. Date: Dec. 19, 2002

(54) Method and apparatus for a user to avoid unintentional calls in a mobile telephone network

(76) Inventor: Bryan Smith, Raa (SE)

Correspondence Address: JENKENS & GILCHRIST, PC, 1445 ROSS AVENUE, SUITE 3200, DALLAS, TX, 75202, US

(21) Appl. No.: 09/882,963

(22) Filed: Jun. 15, 2001

(51) Int. Cl. H04Q 7/20

(52) U.S. Cl. 455/458; 455/567; 455/414

(57) ABSTRACT

In a mobile telephone network, apparatus and method assist the user of a mobile station registered with a first network (-home network-) to abstain from completing a call when the mobile station gets involved with a foreign/international network other than the first network, which might result in unwanted charges. The mobile station includes first and second settings to identify respectively the first network and the foreign/international network. If the mobile station during roaming is connected to a foreign/international network, before a call is consummated, the mobile station produces an ‘indication’ which may be distinct from a normal ringing tone, e.g., a distinct beep or noise or click or even a vibration of the hand held mobile station casing. Simultaneously and optionally, a graphic display in the user's mobile station indicates the identity of the foreign/international network, to show that the call indeed will be routed through a foreign/international network resulting in additional charges. The user thus has the option of not completing initiating/receiving the call, thus avoiding unwanted charges. The first and second settings in the mobile station are user selectable first and second non-text settings where the settings automatically shift to a first setting in the event of a call being a first network call, and to a second setting in the event of the call being a foreign/international call. The first and second non-text settings may be stored in memory within the telephone and can be used to provide one or more different kinds of ‘distinct indication’ which can identify foreign networks from the user's first network or home network.

### FIELD OF INVENTION

This invention generally relates to mobile telephones/mobile stations (MS), and more particularly to a method and apparatus/device for alerting a user, when the user's mobile telephone unintentionally uses a foreign network which is outside of the user's home network.

### BACKGROUND OF THE INVENTION

The use of mobile telephones using cellular telecommunications is increasing with a growth rate presently surpassing that of regular wired telephones. Mobile telephones, in some instances provide customers a variety of service options which have made mobile telephones popular and indispensable. Mobile telephones easily handle messages from one country to another, and usually have the feature of a full graphic text display of up to three rows of text. The graphic display feature can be utilized by the designers to show the user the telephone number of the source of a received call similar to the convenience provided by a caller ID feature. However, more often than not, a MS user will not notice details of the source of the call on the graphic display. Also a MS user would not ordinarily have the ability to identify if a foreign network is involved in the telephone call, e.g., an outgoing call.

Japanese patent publication JP 5268650 teaches a call control system whereby the user can recognize an incoming international call by its ringing tone.

Japanese patent publication JP 11177725 discloses a portable telephone set where a user is made aware of an additional charge being incurred based on the user's time zone, by the use of a sound or vibration.

WO publication 98/59503 discloses a location dependent service for mobile telephones, wherein international calls may be barred when on the home network. In all the foregoing instances of prior art, the user is not easily able to find out if unintentionally an international network is involved in a telephone call which is being handled by a user.

Some systems, by the user's choice prevent a user calling outside of the user's network, but would permit the user to call the home network from outside of the home network. Other systems are known wherein a subscriber/user makes a call to a destination number, and the user is sent information regarding an estimation of charge for completing the call. The system waits for the user's approval to continue with the call. There are other MS systems which permit calls to outside networks at an added charge, but a user may not wish to make such international calls accidentally. Sometimes, a user's network preferences (which can be selected by a user on the user's telephone) are listed on a preferred network listing on the user's Subscriber Identity Module (SIM) which is installed in the user's mobile telephone.

There are situations where a mobile telephone user is located near an international border or proximate to an international or foreign network which is different from the user's home network; the user might initiate or receive a call without being aware that the call will be routed via a second international or foreign network. Networks typically overlap near their borders, and, the user of a mobile telephone encounters overlapping borders especially near the border between two countries. When a mobile telephone user is in the border region between two countries and initiates a call, the user might be connected to a foreign network without realizing it. This can happen especially in situations when a mobile telephone user initiates a call by selecting a name in a list. The telephone number for a call so initiated sometimes includes the international code without the caller being aware thereof. The charges incurred by the user for such a call would be higher because of the connection to the international network, which the user would have liked to avoid if only there had been a forewarning. In some cases, the name of the network to which the mobile telephone is currently connected can be shown on the mobile telephone's display. For example, when using certain Ericsson telephones in Sweden with a subscription from the largest local telephone company “Telia”, the user can see the name“Mobitel” on the telephone display which indicates that the mobile telephone is connected to Telia's mobile phone service. Some telephones can also be programmed to display the name of the network. In GSM (Global System for Mobile Communications) phones, it is not always desirable to display information about the network which the user's telephone is connected to. On some mobile telephones, the indication of the operating company is completely hidden or replaced by some other text or an image chosen by the user.

In some instances, even if the user is warned during the call initiation in a graphic display about the costs caused by the involvement of the second network, the user might not notice the connection to the second network and would unintentionally incur billings for the connection to the second network. A similar situation could easily result also when the user initiates a call using voice dialing using a name which is associated with a telephone number with a built-in international code as part of the telephone number. Voice dialing is presently a feature which is available on many mobile telephone designs and models, an example being the Ericsson T18S, which enables voice dialing for up to ten numbers having associated names, another example being the Ericsson T28S. There are also situations where a user or subscriber gets billed for a received telephone call which is internationally transferred to the user and the user accepts the call without being aware of the involvement of a network outside of the home network. A user becomes annoyed on seeing the mobile station or telephone bill which includes charges for use of the second network which the user was not aware of.

Attempts have been made in prior art to provide GSM systems where MS users are given information on the MS display as to how much an initiated call would cost. However, compiling the cost for calling and presenting it to the user would need equipment to track not only the location of the user, the called party, time of the day, tariff guidelines of the user's network, but also all other parameters which would influence the cost of making the call. Though such tracking is possible, it is nevertheless very expensive because of the hardware and processes involved. Besides, it is not always easy for a user to view the cost of the call on the display and make a quick decision whether to pursue the call. There are users on the other hand who simply wish to be alerted if the call they initiate involves a foreign network. For instance, if the user is calling a receiving party's MS which is normally in the user's own cell or network, but the user has wandered off into a cell belonging to a foreign or international network, if the user can be made aware of such fact, the user might wish to make the call at a later time when the user is back in the user's home network. It would be meaningful and practical for the user to simply know if a pending call involves a foreign network, resulting in added charges.

A need exists therefore for apparatus and method which would enable a user for preventing accidentally and unintentionally completing international calls, or calls involving a foreign/international network, so as to avoid unnecessary charges.

### SUMMARY OF THE INVENTION

The present invention provides apparatus and method for enabling a user of a mobile telephone, to avoid accidentally and unintentionally sending out or receiving a telephone call which includes the participation of a foreign network other than the home network of the user's telephone.

By this invention, the user can have the ability of applying non text settings on the telephone to produce different “indications” to the user in the event of a telephone call, to announce an international network, or even different networks. The indications can be chosen from, e.g., a click, a ringing sound, an acoustic sound, a LED or even a vibration of the telephone casing. The term “non text settings” as used herein is meant to include user selectable telephone settings which do not have any associated readable text.

The invention in its broad form resides in a method of warning a user of a mobile telephone that the user is connected to a second network other than a usual first network, comprising: allocating a first set of specific user-definable non-text settings in the user's telephone to a situation where the user is connected to a first network; allocating a second set of specific user-definable non-text settings in the user's telephone to a situation where the user is connected to a second network; switching the settings automatically to said first set when user's telephone becomes connected to said first network; switching the settings automatically to said second set when the telephone becomes connected to the second network; and alerting the user immediately when the phone is used, by means of the settings, that the user is connected to the first or second network.

The user definable non-text settings in the user's telephone may be built into user selectable profiles held in memory within the user's telephone qto provide indications such as a key sound; acoustic sounds; LED; vibration; and ring signal, where the acoustic sounds may be associated with a prompt used during voice dialing.

In a modification, the indication setting is used in association with one or more of voice dialing, flip opening or key pressing. In a variation, the telephone settings are associated with existing user defined profiles in the mobile telephone. The telephone settings may be in a memory housed inside the user's mobile telephone, and may be programmable.

The invention also resides in a method in a mobile communications system for assisting a user of a mobile telephone to abstain from completing a call involving a foreign/international network, the method comprising the steps of: determining whether the mobile telephone is connected to a foreign/international network outside of the user's home network; and generating, by applying user selectable settings on the user's telephone, and responsive to a determination that the mobile telephone is connected to a foreign/international network, an indication to the user that the call is connected to an international network, thereby giving the user an option of not completing the international network call.

Preferably, the determination is made within the user's telephone, and the network sends to the user's telephone, information including an identification of the international network based on which the determination can be made.

In a variation of the inventive embodiment, the indication comprises a distinct tone or even a musical note instead of a vibration of the user's telephone casing or an LED. It is conceivable that the type of indication is limited only by the designer's imagination and whatever is practical in a mobile telephone.

The inventive apparatus may optionally include an additional graphic display on the user's MS to display information revealing connection to a foreign/international network. Thus, the user would be able to see the graphic display and know the area code and/or the name of the foreign network which became connected to the user's home network call. For example, this can be achieved by the display simply showing the area code or the network name of the second/international network, or, by the display text stating “Call connected to international network. Proceed?” Alternatively, the display might indicate the area code of the international network in a manner such as “Call connected to area code ****. Proceed?” The graphic display, for instance, could be an LCD display.

The invention enables the user of a MS to avoid unwanted or unintentional calls which are linked to a network outside of the MS user's home network. The MS user, from the indication provided by the invention in the MS, e.g., a vibration of the instrument casing, or a special tone or beep or an LED which flashes differently (e.g.,from green to red, or from red to green), would be alerted to pay attention to what is happening to the outgoing/incoming call. The invention also offers to the user the possibility of making profile choices to identify different foreign networks if need be. Different types of indications, e.g., ringing tones which are all different from each other, or, even a combination of indications can be selected by the user to be associated with different networks. The user might thus decide to abort the call, or call later when the user would have returned to a home network known to the user. Variations in the manner in which an indication of the unwanted connection to an outside/international network could be announced to the user, are conceivable and are within the scope of the invention.

Pre-programmed Profiles: In the event the user's telephone includes several pre-programmed profiles such as for example, those which are intended to cater the situations of normal, meeting, in car, outdoors, portable hands-free and home, then, conceivably, some of the profiles can be modified to add a profile for use in a foreign network as desired, to use the present invention. For each profile, variables such as increasing ring, vibrating alert, accept calls, divert calls, light mode, hands-free, silent mode and auto activation can be designed to be “on or off ” as appropriate. For instance, for the “meeting” profile, the vibrating alert can be on, the light setting can be on “auto”, the silent setting can be “on”, and the accept-calls setting can be “from all”. Examples of the pre-programmed profiles which can be modified to obtain the first and second non-text settings for the present invention can be found in the Ericsson manual of the T28 mobile telephone.

### BRIEF DESCRIPTION OF THE DRAWING

A more detailed understanding of the invention can be had from the following description of preferred embodiments, given by way of example and to be understood in conjunction with the accompanying drawing wherein:

FIG. 1 illustrates a prior art GSM system showing the system components and a mobile station (MS) wherein the present invention can be incorporated;

FIG. 2 is a diagrammatic representation of a mobile station (telephone) in which the present invention can be incorporated;

FIG. 3 is a diagram showing two users A and B and a single home network;

FIG. 4 is a diagram showing two networks 1 and 2 located respectively in countries X and Y, where there are two users A and B;

FIG. 5 illustrates the scenario where two networks 1 and 2 respectively of countries X and Y overlap, where two users A and B are both located in country X, but user A is in the overlapping area;

FIG. 6 illustrates a scenario similar to that of FIG. 5, but showing incoming call from user B to user A; and

FIG. 7 illustrates the scenario where networks 1 and 2 are located respectively in countries X and Y, and two users A and B are both located in a network overlapping area.

### DETAILED DESCRIPTION

Described hereinafter, in light of prior art, are preferred embodiments enabling a user of a mobile telephone to be cautioned regarding the involvement of a foreign/international network in a call before the call is completed. The call may be outgoing or incoming. Unlike prior art where cost estimates may be presented to the user in a display in the telephone, an indication to inform the user of a connection to a second or foreign network is provided in the present invention so as to assist the user in making a quick decision whether to complete or abort the call. The invention is especially helpful when the user has the MS turned on and resorted to voice dialing, and is using a hands-off option when the user is not necessarily looking at the graphic display prior to, during, or after initiating the call.

FIG. 1 generally shows a prior art GSM arrangement wherein the GSM network is basically divided into the Switching System (SS) and the Base Station System (BSS). Each of these contains a number of functional units, where all system functions are realized. The functional units are partly in the form of hardware.

The Switching System (SS) typically includes the following functional units: Mobile services Switching Centre (MSC); Visitor Location Register (VLR); Home Location Register (HLR); Authentication Centre (AUC); and Equipment Identity Register (EIR).

The Base Station System (BSS) includes the following units :Base Station Controller (BSC) and Base Transceiver Station (BTS). The arrangement functions as a network of neighboring radio cells, together providing a complete coverage of the total service area. Each cell has a Base Transceiver Station (BTS) operating on a set of radio channels which are different from the channels used in neighboring cells to avoid interference. A group of BTSs is controlled by a Base Station Controller (BSC). BSC controls such functions as handover and channel assignment. Several Base Station Controllers are served by a Mobile services Switching Center (MSC). The MSC controls all calls to and from other telephone and data communication systems, such as the Public Switched Telephone Network (PSTN), Integrated Services Digital Network (ISDN), Public Land Mobile Network (PLMN), Public Data Networks and, possibly, various private networks.

The above-mentioned units are all involved in carrying speech connections between a Mobile Station (MS) and, for example, a subscriber in the PSTN, the fixed network. In order to make calls to a MS, certain further equipment would be needed. The problem arises when it is required to make a MS terminated call. The originator hardly ever knows where the called MS is. Consequently, there is need for certain data bases in the network to keep track of the MS. The most important of these data bases is the Home Location Register (HLR). When a user buys a subscription from one of the GSM operators, the user will be registered in the HLR of that operator. The HLR contains subscriber information, such as supplementary services and authentication parameters. The HLR also contains information about the location of the MS, i.e., in which MSC area and which network the MS resides presently. This information changes when the MS moves. The MS, regardless of its location, will send location information (via the MSC/VLR) to its HLR, thus providing means to receive a call. A unit called Authentication Centre (AUC) is connected to the HLR. The function of the AUC is to provide the HLR with authentication parameters and ciphering keys, both used for security reasons.

The Visitor Location Register (VLR) is a data base containing information about all the MSs (mobile stations) currently located in the MSC area. As soon as an MS roams into a new MSC area, the VLR connected to that MSC will request data about the MS from the HLR. At the same time the HLR will be informed in which MSC the MS is located. The VLR and MSC in the new area may be associated with a network other than the home network of the MS under consideration. If the MS, after entering a new MSC area, wants to make a call, the VLR will have all the information needed for the call set-up without having to interrogate the HLR. The VLR can be seen as a distributed HLR. The VLR will also contain more exact information about the location of the MS in the MSC area, which may be in a second network different from the home network of the MS. In some cases, the connection of a user's MS or a called MS, or both, to the second network results in increased charges for the user's incoming or outgoing call.

The Equipment Identity Register (EIR) illustrated in figure l,preferably contains the unique hardware identity of all the mobile equipment. The EIR is connected to the MSC over a signaling link (not shown), which enables the MSC to check the validity of a proximate MS.

If a caller CR in the fixed network (PSTN) wants to make a call to a GSM subscriber, the exchange in the PSTN will connect the call to a gateway. The gateway function can be realized in a gateway MSC which is known as the GMSC. It can be any of the MSCs in the GSM network (probably most of them). The GMSC will find the location of the searched MS by interrogating the HLR. The HLR will reply with the address to the current MSC area. The GMSC can then re-route the call to the correct MSC. When the call reaches the correct MSC, then the VLR will know in more detail where the Mobile Station, MS is. The call can be switched through.

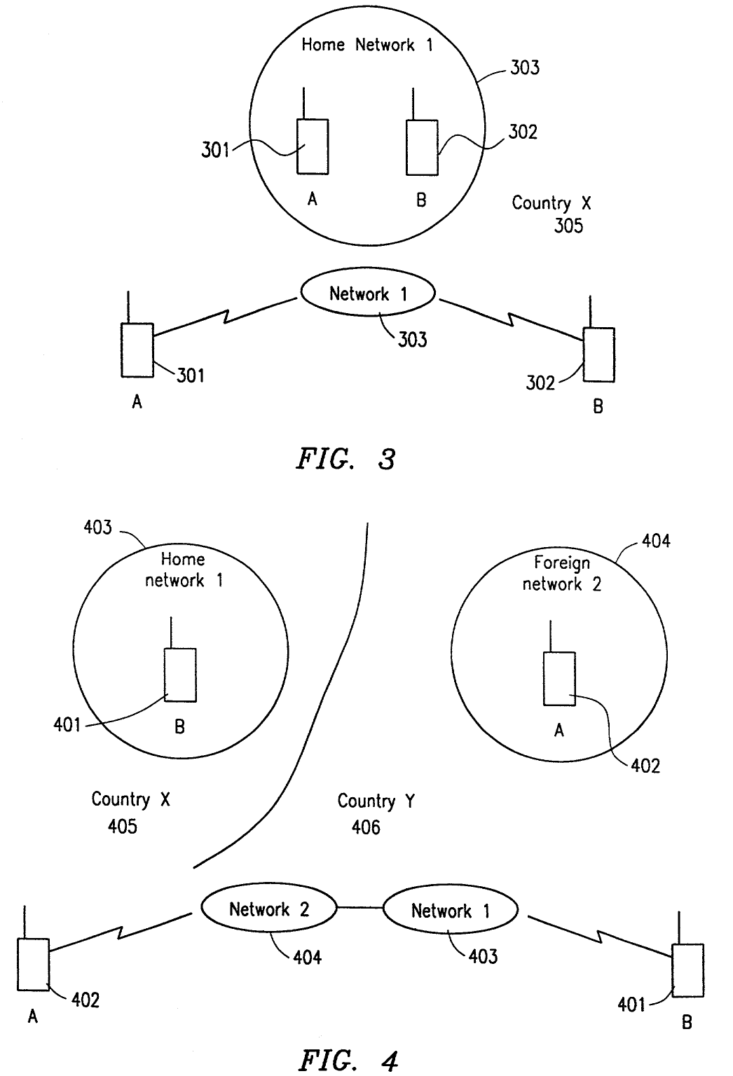

If a mobile station is connected to an international network for any reason as discussed supra and as explained with reference to FIGS. 3 to 7, the user in prior art would not be alerted that the user's mobile station is indeed connected to an international network which would result in additional charges. The user will, however, realize the fact of the involvement of the second network when the bill arrives. Without the present invention there is no simple and reliable manner of the user being warned about the connection of the user's MS to the second network before the user's call, and, the user has no escape from incurring additional charges.

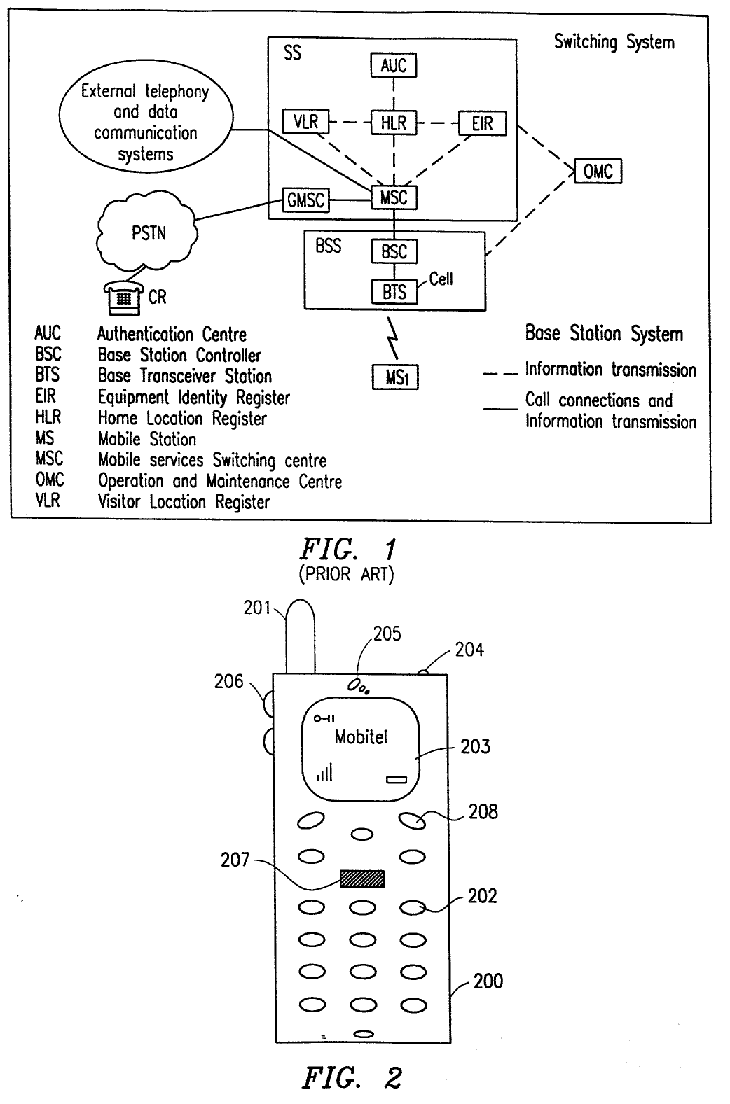

FIG. 2 shows an illustration of a typical mobile telephone wherein the present invention could be incorporated. The user's telephone may be of any suitable design, and advantageously includes a power on/off button, a send button, an ‘end’ button and a number/letter pad and also includes a speaker, a microphone and an antenna. It may have other options to cater voice, redial and memory features. As shown in FIG. 2, the mobile telephone 200 has a casing, an antenna 201, a key pad with various keys 202 which can initiate dialing as well as other multifrequency signaling. A display 203 may include an LCD text display with optional illumination. The display might include several icons which represent signal strength, battery meter, missed call indicator, profile indicator, ring signal off indicator, alarm indicator, voice mail indicator, silence indicator, and others depending on design requirements. The mobile station (telephone) includes a functional indicator 204 which may be a red or a green LED, a microphone 205, an antenna 201,and buttons 206 for voice dialing, and other functions.

FIG. 3 shows a normal case scenario where both user A, shown at 301 and user B, shown at 302, have subscriptions with network 1 shown at 303 in country X, identified by reference numeral 305. User A calling user B will have to pay only the regular calling charge since there is no second network involved.

FIG. 4 shows a scenario where users A and B, shown respectively at 401, 402, both have subscriptions with network 1, 403, in country X, 405. If A visits country Y and calls B via network 2 and network 1, A will incur charges for the use of both networks 1 and 2, i.e.,403 and 404, which will be more than the charges incurred in the scenario of FIG. 3.

FIG. 5 shows a scenario where users or mobile stations A and B, identified respectively by reference numerals 501 and 502, both have subscriptions with network 1, shown at 503, in country X, 505. User A is located in country X, but A's mobile station is able to register with network 2,identified by reference numeral 504, from country Y, 506. Depending on which network the phone connects to, an outgoing call may be routed through network 1 only and incur no additional charges, or, through network 2 (504), and network 1(503), incurring additional charges, even if the user does not know that a second foreign network 504 is also involved.

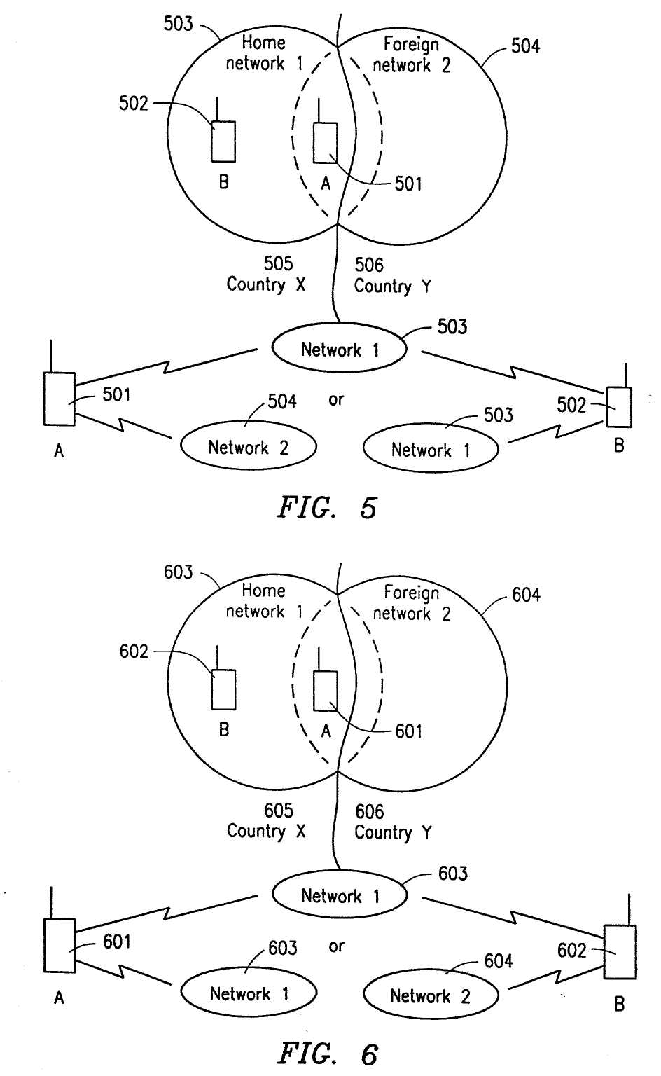

FIG. 6 shows a scenario where both users A and B with mobile stations 601 and 602 respectively, have subscriptions with network 1 (603) in country X(605). Even though A is situated in country X, his MS can register with network 2 (604) from country Y(606). User A may have to pay charges for an incoming call transfer which involves network 2 (604)in addition to network 1 (603).

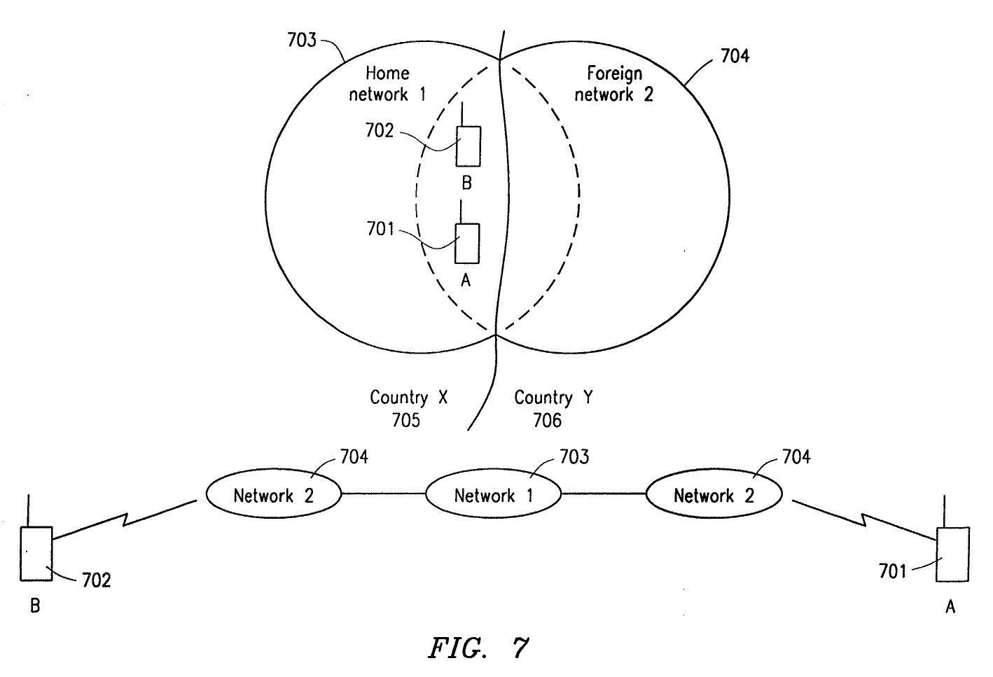

FIG. 7 shows a scenario similar to that in FIG. 6, having users A and B with mobile stations 701 and 702 respectively, both registered with network 1, i.e., 703, in country X, i.e.,705. In the event that both the mobile stations are roaming and both come into the domain of network 2, i.e., 704, the situation is different from the one illustrated in FIG. 6 in that user B also is connected to network 2 by mistake, or unintentionally. B will have to pay additional charges to make a call to user A since the call is routed from network 2 to network 1 to network 2. Likewise, A will have to pay additional charges to make a call to B or to receive a call from B through network 2 to network 1 to network 2. In the scenarios illustrated in FIGS. 4,5,6 and 7, a user's mobile station is unknowingly connected to a second foreign network. In situations where the user's mobile station becomes connected to a second network, as shown in FIGS. 4, 5, 6 and 7, if the user unintentionally completes the call, the user would have to pay additional charges. The present invention alerts the user of a mobile station to a situation where the mobile station is connected to a second international network with which the mobile station is not initially registered. By the user becoming alerted as in the present invention, the user, by not completing the call, is prevented from incurring unintended additional charges. A preferred embodiment of the invention can be implemented as follows.

In a preferred form of the present invention, first and second specific user-definable non-text settings are chosen, and the user's mobile station, as exemplified in FIG. 2, is capable of switching from the first to the second setting and vice versa. If the mobile station senses that a call which is being handled is associated with a second international network, then the mobile station will switch to the second set of settings. The first and second set of settings may be distinguishable in more than one way. The two settings may be identified to the user by different kinds of ringing tones; or, the two settings may be identified by a beep and a click, respectively. Or, one of the two settings can be identified by vibration of the casing of the user's mobile station. In this context, it may be noted that preprogrammed profiles for mobile stations, as described supra, are able to offer a variety of different indications to the user, including, e.g., a tone, a normal ring, a beep, a light vibration of the casing. In accordance with the preferred embodiment present invention, a choice can be made from these same types of indications, but in this case the indications are used for identifying the first setting and the second setting. Having chosen the indication for the first and second settings once, the user can subsequently change the indications by reprogramming the telephone. To this end, the telephone houses suitable memory, as well as switching and programming provisions which would be intelligible to those skilled in the art.

In a preferred embodiment, a first network which is connected to the user's mobile station (MS) might automatically switch the MS to a first setting which the user can identify. A second network such as a foreign network when connected to the telephone might automatically switch the MS to a second setting to produce an indication, e.g., a click or a distinct sound which the user knows to associate with a foreign network.

An additional provision may be made for the user to set the MS so that a call is not completed when the MS is connected to a network outside of the user's first network unless the user removes the restriction. The MS may include a display indicating connection to the second network.

It is emphasized that the term “comprises” or “comprising” wherever used in this text and the accompanying claims is to be understood as specifying the presence of stated features, integers, steps or components but does not preclude the presence of one or more other features, integers, steps, components or groups thereof.

The term “mobile telephone” or “mobile station” (MS) as used herein is to be understood to include mobile telephones, pagers, communicators, electronic organizers, smart phones, PDA( Personal Digital Assistant), portable communication apparatus and the like.

The foregoing description provides a method and apparatus for easily cautioning a caller using a MS, of the fact that a network outside of the user's home network is connected with the MS, thus giving the user an opportunity to quickly evaluate the call to decide whether to continue or abort the call. The user does not have to bother with understanding the tariff to make the quick evaluation. The apparatus is relatively inexpensive compared to the cost of other complex systems which compute the cost to call. The user can change the definition of which network is to be considered foreign, by a suitable choice of a profile or by altering the profile setting if the design permits. The invention is especially advantageous in voice dialing situations where a call is simply voice-dialed based on a called party's name. The invention is especially helpful for a user to avoid an unintentional international call where the user exercises the hands-off option with a MS when the user is not usually looking into the display on the telephone.

Advantageously, the invention might enable a user to choose or arrange different first and second settings to identify respectively the user's home network, and one or more second or international networks.

### Equivalents

Although preferred embodiments of the method and apparatus of the present invention have been illustrated in the accompanying drawings as described in the foregoing detailed description, it will be understood that the invention is not limited to the embodiments disclosed, but is capable of numerous rearrangements, modifications, equivalents and substitutions without departing from the scope of the invention as set forth in the appended claims.

1. A method of alerting a user of a mobile telephone that the user is connected to a second network other than a usual first network, comprising:
allocating a first set of specific user-definable non-text settings in the user's telephone to a situation where the user is connected to a first network;
allocating a second set of specific user-definable non-text settings in the user's telephone to a situation where the user is connected to a second network;
switching the settings automatically to said first set when user's telephone becomes connected to said first network;
switching the settings automatically to said second set when the telephone becomes connected to the second network;
alerting the user immediately before a call is activated, by an indication caused by said first and second non-text settings respectively that the user is connected to the first or second network.

2. A method as in claim 1, wherein said non-text settings in the user's telephone may be selected from indications including:
key sound;
acoustic sounds;
Led;
vibration; and
ring signal.

3. A method as in claim 2, wherein the acoustic sounds are associated with a prompt used during voice dialing.

4. A method as in claim 2, wherein said vibration setting is used in association with one or more of voice dialing, flip opening or key pressing.

5. A method as in claim 2, wherein an incoming call is associated with a ring signal, the method including the step of the user selecting if the ring signal should be associated with a first or second network.

6. A method as in claim 1, wherein the first network may be a user's home network/a preferred network.

7. A method as in claim 6, wherein the second network may be a foreign network other than the user's home network/preferred network.

8. A method as in claim 1, wherein the user's telephone includes a display which can show an identification of a current connected network which may be confirmed by the user reading text on the display.

9. A method as in claim 8, where the first network is a home/preferred network.

10. A method as in claim 8, wherein the second network is a foreign network other than the user's home network/preferred network.

11. A method as in claim 1, wherein the non-text settings are associated with user defined profiles in the mobile telephone.

12. The method as in claim 1, including providing a graphic display on the user's telephone, said display including information regarding any international network to which a user's call is connected.

13. The method as in claim 12, wherein said graphic display comprises a display chosen from an LCD display and an LED display.

14. The method as in claim 1, including voice dialing and activating, connected with an outgoing call.

15. Apparatus in a user's mobile telephone to alert the user that the user is connected to a second network other than a usual first network, comprising:
a first set of specific user-definable non-text settings in the user's mobile telephone for use when the user's mobile telephone is connected to a first network;
a second set of specific user-definable non-text settings in the user's mobile telephone for use the user's mobile telephone is connected to a second network;
circuitry for switching automatically to said first set when user's mobile telephone is connected to said first network, and for switching automatically to said second set when user's mobile telephone is connected to the second network;
an indicator for alerting the user immediately when the phone is used, by use of said first and second sets of non-text settings that the user is connected to the first or second network.

16. Apparatus as in claim 15, wherein said non-text settings in the user's telephone may be selected from indications including:
key sound;
acoustic sounds;
LED;
vibration; and
ring signal.

17. Apparatus as in claim 11, wherein said indicator comprises a vibration mechanism coupled to a casing of said user's mobile telephone to selectively cause vibration of the casing.

18. Apparatus as in claim 11, wherein said indicator comprises a mechanism t selectively produce an acoustic signal.

19. Apparatus as in claim 11, wherein said indicator comprises an LED which is connected to be selectively lit by said first and second non-text settings in the user's telephone.

20. Apparatus as in claim 16, wherein the acoustic sounds are associated with a prompt used during voice dialing.

21. Apparatus as in claim 16, wherein said vibration setting is used in association with one or more of voice dialing, flip opening or key pressing.

22. Apparatus as in claim 16, wherein an incoming call is associated with a ring signal, wherein the user can select if the ring signal should be associated with a first or second network.

23. Apparatus as in claim 15 for use in a first network, wherein the first network may be a user's home network/preferred network.

24. Apparatus as in 23, wherein the second network may be a network other than the user's home network/preferred network.

25. Apparatus as in claim 15, wherein the user's telephone includes a display which can show an identification of a current connected network which may be confirmed by the user reading text on the display.

26. Apparatus as in claim 25, wherein the second network is a foreign network.

27. Apparatus as in claim 25, wherein the second network may be any network other than the user's home network/preferred network.

28. Apparatus as in claim 15, wherein said non-text settings are associated with user defined profiles in the mobile telephone.
